(19) United States
(12) Patent Application Publication
(10) Pub. No.: US 2007/0023180 A1
(43) Pub. Date: Feb. 1, 2007

(54) Multizone air conditioning system of a motor vehicle

(75) Inventors: Eugen Komarek, Heidelberg (DE); Matthias Schall, Stuttgart (DE); Otto Schulten, Illingen (DE)

Correspondence Address: FOLEY AND LARDNER LLP;SUITE 500, 3000 K STREET NW, WASHINGTON, DC, 20007, US

(73) Assignee: BEHR GMBH & CO. KG

(21) Appl. No.: 10/575,946

(22) PCT Filed: Sep. 10, 2004
(86) PCT No.: PCT/EP04/10149

§ 371 Date: Apr. 13, 2006

(30) Foreign Application Priority Data
Oct. 15, 2003 (DE) 103 48 649.6

(51) Int. Cl. B60H 3/00; B60H 1/00

(52) U.S. Cl. 165/202; 165/42

(57) ABSTRACT

The invention relates to a multizone air conditioning system (1) of a motor vehicle, comprising, when observed from the direction of airflow, a regulating organ (7′) for regulating the temperature, an evaporator (4) and a heating element (5), which are arranged in an air guiding housing (2). Said air guiding housing (2) has partition walls (8) and at least one partition element (9;16) for tightly separating the individual zones of the air conditioning system (1) in the heating element (5) and/or a heater (6), said partition wall cooperating with the partition walls (8) and/or partition elements (6;19) of adjacent components or the network of the heating element is as wide as the adjacent collecting tanks of the heating element in the direction of airflow and is tightly and directly located on a partition wall.

The invention relates to a multizone air conditioning system of a motor vehicle, in accordance with the preamble of claim 1.

In conventional multizone air conditioning systems of motor vehicles, as viewed in the direction of airflow, the heater is usually arranged first, followed optionally by a supplementary heater, then a control element for controlling the temperature and subsequently the mixing chamber, with the result that relatively simple and exact temperature control is possible. However, an arrangement of this type has the disadvantage that, in the case of the delivery of cool air, the warm heater can be arranged directly in the airflow of the cold path. In this case, undesirable heating of the air (residual heating) occurs which is associated with an insufficient cooling performance of the air conditioning system or an unsatisfactory control behavior of the air conditioning system, in particular in the lower, cooler control range.

If, as viewed in the direction of airflow, the arrangement is the control element, the heater, optionally the supplementary heater and subsequently the mixing chamber, problems occur when dividing the zones, with the result that the control behavior likewise leaves something to be desired.

It is an object of the invention to make an improved multizone air conditioning system available, in particular with regard to the division of zones and optimized temperature control of the individual zones.

This object is achieved by a multizone air conditioning system having the features of claim 1 or claim 10. Advantageous refinements are the subject matter of the subclaims.

According to the invention, a multizone air conditioning system of a motor vehicle is provided, having, as viewed in the direction of airflow, a control element for controlling the temperature, a vaporizer and a heater which are arranged in an air guiding housing, the air guiding housing having dividing walls, and at least one dividing element for the sealed division of the individual zones of the air conditioning system being provided on the heater and/or on a supplementary heater, which dividing elements interact with components which are adjacent to the dividing walls and/or dividing elements, with the result that optimum temperature control is possible in every zone without influences from adjacent zones.

As an alternative, in particular, the heater can be configured in such a way that it has no undercuts in the installation direction and bears with its network directly against the dividing walls of the air guiding housing. Here, the network of the heater is as wide in the direction of airflow as the adjacent collecting tanks of the heater and bears tightly directly against a dividing wall. In this case, a dividing wall can also be a dividing element which is provided on an adjacent component, for example the heater. In both ways, a transverse flow of the air can be prevented reliably, with the result that the temperature can be controlled in an optimum manner in every zone. Of course, combinations of both the embodiments are also possible.

As viewed in the direction of airflow, the control element is preferably arranged in front of the heater, one control element being provided, in particular, per zone of the multizone air conditioning system.

Behind the control element, any desired supplementary heater, in particular, however, a PTC supplementary heater, can be provided arranged ahead of or behind the heater.

The dividing element can be provided on the heater and/or supplementary heater, it being possible, in particular, for it to be clipped (in particular onto the heater), injection molded directly (in particular onto a supplementary heater), or fastened thereto in another way. Clipping makes simple assembly possible; injection molding can take place directly in the context of the manufacturing process, in particular of a PTC supplementary heater. Here, the dividing element is, in particular, a plastic injection molded part.

The dividing element is preferably configured in such a way that it bridges an undercut which is present between the network of the heater and the collecting tanks of the heater, with the result that no transverse flow of the air is possible between the individual zone air ducts.

The dividing element is preferably of cross-shaped configuration, said dividing element having a frame which is preferably of approximately rectangular configuration, increases the stability of the dividing element and additionally improves the lateral sealing action. Depending on the construction of the contact point, however, only horizontal or vertical dividing elements are also possible, both with and without frames. The dividing element can likewise also extend only in a horizontal direction, in a vertical direction or obliquely.

If an air conditioning system is configured in a modular manner, it being possible for a supplementary heater to be omitted in one variant, additional dividing elements can be used which extend the dividing walls over the width of the installation space of the supplementary heater, with the result that the other components do not have to be adapted. As a result, the production numbers can be increased and the manufacturing costs can therefore be reduced.

In the following text, the invention will be explained in detail using two exemplary embodiments with one variant, partially with reference to the drawing, in which:

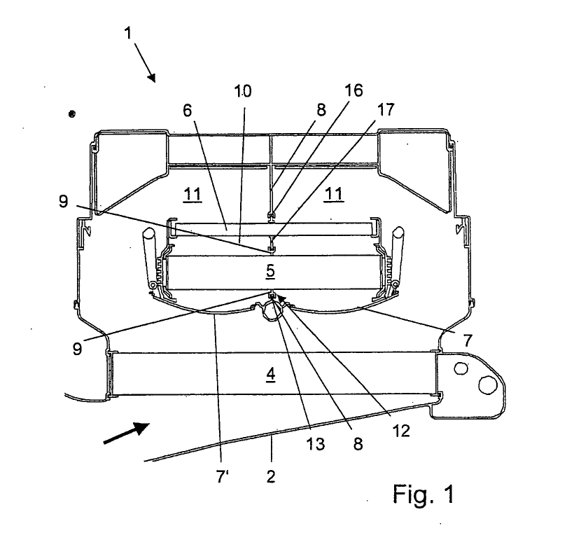

FIG. 1 shows a plan view of an air conditioning system according to the exemplary embodiment,

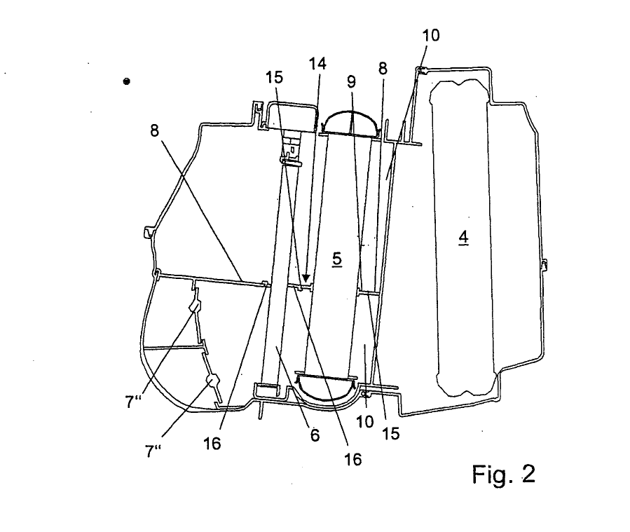

FIG. 2 shows a side view of the air conditioning system from FIG. 1,

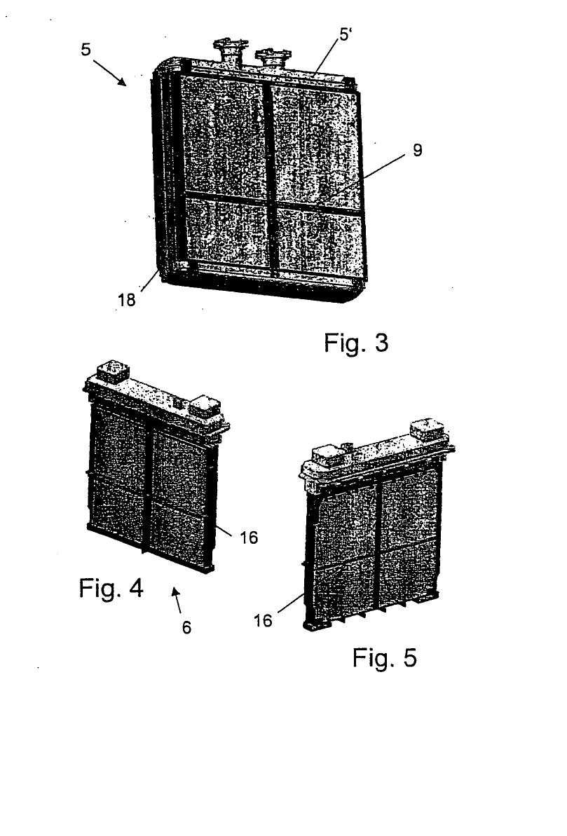

FIG. 3 shows a view of the heater from FIG. 1,

FIG. 4 shows a view of the PTC supplementary heater from FIG. 1, and

FIG. 5 shows a further view of the PTC supplementary heater from FIG. 1.

A multizone air conditioning system 1 of a motor vehicle has, in an air guiding housing 2, a fan (not shown), a vaporizer 4 and a heater 5 having a PTC supplementary heater 6 which is arranged behind it as viewed in the direction of airflow, for air temperature control, and a multiplicity of control elements 7, such as mixing flaps 7′, which serve to control the guiding of air through the vaporizer 4 and heater 5 (temperature control of the individual zones) and to distribute the air to air ducts (flaps 7″) to the individual regions of the individual zones.

A division into a plurality of zones takes place via the individual mixing flaps 7′, with the result that air ducts 10 and mixing chambers 11 which are divided by dividing walls 8 and dividing elements 9 are adjacent to every mixing flap 7′. The dividing elements 9 are clipped onto the heater 5 on both sides by means of in each case four clip connections (see FIG. 3), with the result that the heater 5 with the dividing elements 9 has no undercuts in the installation direction into the air guiding housing 2, that is to say that that edge of the dividing elements 9 which, as viewed in the direction of airflow, is spaced apart from the heater 5, ends at the same level as that edge of the collecting tanks 5′ of the heater 5 which lies on this side, and an accurate installation of the heater 5 into the air guiding housing 2 is possible with sealing contact of the dividing elements 9 on the dividing walls 8. According to the present exemplary embodiment, the dividing elements 9 have a continuous groove 13 in their region 12 which extends in the installation direction (see FIG. 1). A contact point 15 is provided in the region 14 which extends transversely with respect to the former. According to the present exemplary embodiment, the dividing element 9 which is arranged on the PTC supplementary heater side bears directly against a dividing element 16 which is provided on the PTC supplementary heater 6 and is injection molded directly onto the latter, with a corresponding function.

The dividing element 16 has webs 17 which are continuous in the installation direction and engage in the grooves which are formed on the corresponding dividing wall 8 of the air guiding housing 2 or, in the case of the dividing element 16 which is provided on the other side of the PTC supplementary heater 6, into the groove 13 which is provided on the dividing element 9 which is provided on the heater 5. The configuration of the contact points, dividing elements and dividing walls is dependent on the sequence of installation, the contact points, dividing elements and dividing walls being configured in such a way that a reliable sealing action is possible.

In addition to the sealing action in the central region which is cross-shaped in the present case, the dividing elements 9 and 16 also serve to seal in the edge regions of the heater 5 and the PTC supplementary heater 6, for which reason they are configured accordingly. In the present four-zone air conditioning system 1, the dividing element 9 therefore has a rectangular frame 18 which also serves to increase the stability of the dividing element 9.

According to a variant which is not shown in the drawing, the PTC supplementary heater 6 is omitted, with the result that the dividing elements which are clipped onto the heater interact with correspondingly configured dividing walls and the sealing action is ensured between the individual zones of the air conditioning system. Here, the dividing walls can also be replaced by an additional dividing wall module which is installed in place of the PTC supplementary heater.

In accordance with a second exemplary embodiment having a heater which is arranged after mixing flaps, the heater is configured in such a way that the network which is arranged between the two collecting tanks is configured, as viewed in the direction of airflow, to be as wide as the collecting tanks, with the result that no undercut is provided and an accurate installation of the heater into the air guiding housing is possible with sealing contact against the dividing walls. Here, the dividing walls are provided with special sealing elements which bear against the network, with the result that no transverse flow of the air is possible.
1 List of Designations
2 Air conditioning system of a motor vehicle
3 Air guiding housing
4 Vaporizer
5 Heater
6 PTC supplementary heater
7 Control element
7′ Mixing flap, control element
7″ Flap
8 Dividing wall
9 Dividing element (heater)
10 Air duct
11 Mixing chamber
12 Region
13 Groove
14 Region
15 Contact point
16 Dividing element (PTC supplementary heater)
17 Web
18 Frame

1. A multizone air conditioning system of a motor vehicle, having, as viewed in the direction of airflow, a control element for controlling the temperature, a vaporizer and a heater which are arranged in an air guiding housing, the air guiding housing having dividing walls, characterized in that at least one dividing element for the sealed division of the individual zones of the air conditioning system is provided on the heater and/or on a supplementary heater, which dividing element interacts with components which are adjacent to the dividing walls and/or dividing elements.

2. The air conditioning system as claimed in claim 1, wherein the control element is arranged in front of the heater.

3. The air conditioning system as claimed in claim 1, wherein one control element is provided per zone.

4. The air conditioning system as claimed in claim 1, wherein a supplementary heater is provided arranged ahead of or behind the heater.

5. The air conditioning system as claimed in claim 1, wherein the dividing element is provided on the heater and/or supplementary heater.

6. The air conditioning system as claimed in claim 5, wherein the dividing element is injection molded or clipped onto the heater and/or onto the supplementary heater.

7. The air conditioning system as claimed in claim 5, wherein the dividing element bridges an undercut which is present between the network of the heater and the collecting tanks of the heater.

8. The air conditioning system as claimed in claim 1, wherein the dividing element is of cross-shaped configuration.

9. The air conditioning system as claimed in claim 1, wherein the dividing element has a frame.

10. A multizone air conditioning system of a motor vehicle, having, as viewed in the direction of airflow, a control element for controlling the temperature, a vaporizer and a heater having a network and collecting tanks which are arranged in an air guiding housing the air guiding housing having dividing walls characterized in that the network of the heater is as wide in the direction of airflow as the adjacent collecting tanks of the heater and bears tightly directly against a dividing wall.
